(19) United States
(12) Patent Application Publication
(10) Pub. No.: US 2011/0043711 A1
(43) Pub. Date: Feb. 24, 2011

(54) VIDEO SIGNAL LINE DRIVING CIRCUIT AND LIQUID CRYSTAL DISPLAY DEVICE

(75) Inventors: Takuya Tsuda, Osaka-shi (JP); Nozomu Kohsaka, Osaka-shi (JP); Keisuke Yoshida, Osaka-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi, Osaka (JP)

(21) Appl. No.: 12/989,773

(22) PCT Filed: Apr. 28, 2009
(86) PCT No.: PCT/JP2009/058404

§ 371 Date: Nov. 9, 2010

(30) Foreign Application Priority Data
Apr. 28, 2008 (JP) 2008-117433

(51) Int. Cl. H04N 3/14; G09G 5/00

(52) U.S. Cl. 348/790; 345/211; 348/E03.016

(57) ABSTRACT

A source driver of the present invention is for driving a source signal line provided in a liquid crystal display device and varies, based on distribution of an optimum common-electrode electric potential calculated by a flicker minimum value determining method over a line perpendicular to video signal lines, an electric potential of an output signal in accordance with to which video signal line the output signal is to be outputted. A center electric potential of the output signal is greater as the video signal line is farther from an approximate center of a display surface of the liquid crystal display device toward at least one end of the display surface. Thus, the present invention provides a video signal line driving circuit for preventing (i) in-plane flicker which arises due to distribution of an optimum electric potential varying in accordance with distances from a scanning signal line driving circuit and (ii) in-plane flicker which arises due to distances from the scanning signal lines and shifts by CS trunk line resistance.

### TECHNICAL FIELD

The present invention relates to a video signal line driving circuit and a liquid crystal display device including the same.

### BACKGROUND ART

There has been a trend that a display screen of a small-sized to middle-sized liquid crystal display for use in a mobile device has high definition and an increased size (VGA, size 3 or greater). However, this has made a problem regarding in-plane flicker, i.e., a problem that due to distribution of feed-through voltages in a display screen, it is impossible to prevent flicker on entire display screen basis, more serious.

A mechanism on which in-plane flicker occurs is described below.

FIG. 21 is a view showing a configuration of a normal liquid crystal display of active matrix type.

As shown in FIG. 21, the liquid crystal display includes: a source driver (signal line driver) 110; signal lines S1 through SN (102) connected to the source driver 110 and extending in a lengthwise direction; a gate driver (scanning line driver) 120; scanning lines G1 through GM (101) connected to the gate driver 120 and extending in a crosswise direction; a pixel formed in each of intersections between the signal lines S1 trough SN and the scanning lines G1 through GM; and a TFT 103 provided in each of the intersections between the signal lines S1 through SN and the scanning lines G1 through GM. The signal lines S1 through SN and the scanning lines G1 through GM are orthogonal to one another, and in each of the intersections therebetween, the pixel is formed and the TFT 103 is provided.

As shown in an enlarged view in FIG. 21, the pixel includes the TFT 103 and a common electrode 107, and has Cgd (gate-drain parasitic capacitance) 104, Clc (liquid crystal pixel capacitance) 105, and Cs (storage capacitance) 106.

When a gate signal (scanning line signal) falls off, parasitic capacitance residing in between a gate and a drain of a TFT 103 causes a voltage shift of a drain electric potential, which voltage shift is called field-through (a phenomenon that, when an electric potential of a gate signal line is shifted to a level causing a pixel TFT to be turned off, an electric potential of a pixel electrode is pulled in, by a degree of ΔV, into the same direction in which the electric potential of the gate signal line is shifted. ΔV is referred to as a punch-through voltage or a field-through voltage). Such field-through causes burn-in and flicker in a liquid crystal display panel. Details regarding the feed-through are disclosed in Patent Literature 4.

FIG. 22 is a waveform chart showing driving signals at a point A shown in FIG. 21. FIG. 23 is a waveform chart showing driving signals at a point B shown in FIG. 21. In FIGS. 22 and 23, a indicates a field-through electric potential (VFD), b indicates an actual field-through electric potential, c indicates a voltage shift which occurs due to resupply signal, and Δt indicates a period between start of falling-off of a gate signal and turning-off of TFT. As shown in FIG. 21, the point A is located closer to a gate driver output than the point B to the gate driver output.

The field-through electric potential (VFD) is shown by Equation 1 below.

VFD=Cgd*(Vgh−Vgl)/(Clc+Cs+Cgd) Equation 1,

where

Cgd is gate-drain parasitic capacitance of TFT,

Clc is pixel capacitance,

Cs is storage capacitance,

Vgh is a gate-signal high electric potential, and

Vgl is a gate-signal low electric potential.

In Equation 1, it is assumed that a gate signal (scanning line signal) is an ideal gate signal having a rectangular waveform. However, in a real panel having a large screen and high resolution, a scanning line is long in length and intersects with a number of signal lines. As such, ON-resistance and parasitic capacitance of a transistor (TFT) are greater, thereby causing a waveform of a gate signal (scanning line signal) to decay with time constant. That is, a delay Δt arises within period between start of falling-off of the gate signal (scanning line signal) and turning-off of the TFT. During a period of the delay Δt, a voltage is supplied to a drain electrode via a corresponding source signal line, and as such, a voltage shift c occurs. The voltage shift c is shown by Equation 2.

c=∫IDS*Δt/(Clc+Cs+Cgd) Equation 2, where:

∫IDS is an average current which flows from a drain electrode to a source electrode via a TFT during Δt; and

Δt is a time period between start of falling-off of a gate signal (scanning line signal) and turning-off of the TFT. An actual field-through voltage obtained by offsetting the voltage shift is shown by Equation 3.

VFD={Cgd*(Vgh−Vgl)+∫IDS*Δt}/(Clc+Cs+Cgd) Equation 3.

Generally, at a point A closer to the gate driver output, a delay Δt of the gate signal waveform is relatively small as shown in FIG. 22. On the other hand, at a point B farther from the gate driver output, a delay Δt of the gate signal waveform is greater than that at the point A, as shown in FIG. 23. Thus, voltage shifts c due to resupply signal, which are found by Equation 2, have in-plane distribution. This in turn causes actual field-through voltages b found by Equation 3 to have distribution. Therefore, distribution of optimum common electric potentials over a line perpendicular to the source signal lines is as shown in FIG. 24.

Flicker is prevented by correcting a field-through electric potential. For this purpose, an electric potential (common electric potential) of a common electrode is adjusted, generally. However, the common electric potential is same across a screen, whereas field-through electric potentials have distribution over the line perpendicular to the source signal lines. Therefore, there is a problem that even in a case where the common electric potential is adjusted in order that flicker at one point of the display screen can be prevented, this does not prevent flicker at another point of the display screen.

Patent Literatures 1 and 2, etc, disclose a technique of Cgd gradation which deal with the problem. In a normal display screen, employing the Cgd gradation makes it possible to reduce in-plane flicker to a level substantially unproblematic. However, in some particular types of display screens (e.g., common adjustment screen used in production process), the Cgd gradation fails to work sufficiently accurately, and as such, it is necessitated that the Cgd gradation be further improved. By the Cgd gradation, capacitances are formed between gates and drains of respective TFTs, in advance, in such a manner that at the point A closer the gate driver output, capacitance is smaller and at the point B farther from the gate drive output, capacitance is greater. By this, the distribution of optimum common electric potentials is uniformly offset.

In actual designing, as shown in FIG. 25, it is arranged so that a liquid crystal screen is divided into a plurality of regions, and capacitance values in the respective plurality of regions are varied. Thus, an offset characteristic in the actual designing is of a polygonal line as shown in FIG. 25. However, such polygonal line is merely approximate to an actual offset character, and as such, there is a case in which, in a part near a boundary between the regions, a difference between the offset characteristic and the actual offset characteristic appears as if it were an error. It is therefore necessary that adjustment and arrangement in the designing be performed. As discussed so far, means for forming storage capacitance in a panel can have a limited accuracy. Further, the means in which storage capacitance is formed near a pixel may cause a reduction of a transmission rate of the panel in some cases.

On the other hand, Patent Literature 4 discloses a liquid crystal display device which employs the following means in order to cause an image display characteristic in even a large-sized TFT liquid crystal display device to be uniform. In the liquid crystal display device, it is arranged so that a voltage to be applied across a common substrate extending in a region corresponding between an input end and a tail of a scanning signal line has a slope in conformity with an optimum common-electrode electric potential calculated by the flicker minimum value determining method.

### Citation List

Patent Literature 1

Japanese Patent Application Publication, Tokukaihei, No. 11-84428 A (Publication Date: Mar. 26, 1999)

Patent Literature 2

Japanese Patent Application Publication, Tokukai, No. 2002-236296 A (Publication Date: Aug. 23, 2002)

Patent Literature 3

Japanese Patent Application Publication, Tokukai, No. 2006-171022 A (Publication Date: Jun. 29, 2006)

Patent Literature 4

Japanese Patent Application Publication, Tokukai, No. 2001-296843 A (Publication Date: Oct. 26, 2001)

Patent Literature 5

Japanese Patent Application Publication, Tokukai, No. 2002-91391 A (Publication Date: Mar. 27, 2002)

### SUMMARY OF INVENTION

However, means as disclosed in Patent Literature 5, which simply skews voltages to be applied, poses a problem that it can only offset a shift by CS trunk line resistance, while not being capable of offsetting distribution of optimum common electric potentials caused under influence varying accordingly with distances from a scanning signal line driving circuit and distribution of optimum common electric potentials caused under influence varying accordingly with distances from the scanning signal line driving circuit and a shift by CS trunk line resistance.

The present invention is made in view of the problems, and an object of the present invention is to provide a video signal line driving circuit and a liquid crystal display device, each being capable of preventing: in-plane flicker arising due to distribution of optimum common electric potentials varying in accordance with distances from the scanning signal line driving circuit; and in-plane flicker arising in accordance with distances from the scanning signal line driving circuit and the shifts by CS trunk line resistance.

In order to attain the object, a video signal line of the present invention is a video signal line driving circuit for driving video signal lines formed in a liquid crystal display device, wherein: the video signal line driving circuit varies, based on distribution of optimum common-electrode electric potentials over a line perpendicular to the video signal lines, which optimum common-electrode electric potentials are calculated by a flicker minimum value determining method, an electric potential of an output signal in accordance with to which video signal line the output signal is to be outputted; and the electric potential of the output signal is greater as the video signal line is farther from an approximate center of a display surface of the liquid crystal display device toward at least one end of the display surface.

Note that the distribution of optimum common-electrode electric potentials over a line perpendicular to the video signal lines, which optimum common-electrode electric potentials are calculated by the flicker minimum value determining method, is based on feed-through electric potentials by signal delay of a scanning signal and/or feed-through electric potentials by CS (storage capacitor) electric potentials.

In a liquid crystal display device which receives, from two ends of it, storage capacitor signals supplied from a storage capacitor signal source used in the liquid crystal display device, an optimum common-electrode electric potential calculated by the flicker minimum value determining method is smaller as a common electrode is farther from an approximate center of a display surface of the liquid crystal display deice toward at least one end of the display surface. Taking this into account, it is arranged so that an electric potential of an output signal is greater as a video signal line to be applied with the output signal is farther from the approximate center of the display surface of the liquid crystal display device toward at least one end of the display surface. This makes is possible to offset the distribution of optimum common-electrode electric potentials over the line perpendicular to the video signal lines, which optimum common-electrode electric potentials are calculated by the flicker minimum value determining method. Thus, by employing the arrangement in the liquid crystal display device which receives, from two ends of it, the storage capacitor signals supplied from the storage capacitor signal source, it is possible to offset the distribution of optimum common-electrode electric potentials over the line perpendicular to the video signal lines, which optimum common-electrode electric potentials are calculated by the flicker minimum value determining method.

In order to attain the object, a video signal line driving circuit of the present invention is a video signal line driving circuit for driving video signal lines formed I a liquid crystal display device, wherein: the video signal line driving circuit varies, based on distribution of optimum common-electrode electric potentials over a line perpendicular to video signal lines, which optimum common-electrode electric potentials are calculated by a flicker minimum value determining method, an electric potential of an output signal in accordance with to which video signal line the output signal is to be outputted; and the electric potential of the output signal is greater as the video signal line is farther from a certain position of a display surface of the liquid crystal display device toward at least one end of the display surface, which certain position of the display surface is closer to one end of the display surface than an approximate center of the display surface to the one end of the display surface.

Note that the distribution of optimum common-electrode electric potentials over a line perpendicular to the video signal lines, which optimum common-electrode electric potentials are calculated by the flicker minimum value determining method, is based on feed-through electric potentials by signal delay of a scanning signal and/or feed-through electric potentials by CS (storage capacitor) electric potentials.

An optimum common-electrode electric potential calculated by the flicker minimum value determining method is greater as a distance from the scanning signal line driving circuit used in the liquid crystal display device is greater. Also, in a liquid crystal display device which receives, from two ends of it, storage capacitor signals supplied from a storage capacitor signal source used in the liquid crystal display device, an optimum common-electrode electric potential is smaller as a common electrode is farther from an approximate center of a display surface of the liquid crystal display device toward at least one end of the display surface. Thus, taking into account distributions of optimum common-electrode electric potentials calculated by the flicker minimum value determining method over a line perpendicular to the video signal lines which distributions arise under influences in such cases, it is arranged so that an electric potential of an outputs signal of the video signal line driving circuit is greater as a video signal to be applied with the output signal is farther from a certain position of a display surface of the liquid crystal display device toward a least one end of the display surface, which certain position of the display surface is closer to one end of the display surface than an approximate center of the display surface to the end. By this, it is possible to offset the distributions. Thus, the liquid crystal displays which employ the arrangement can deal with (i) distribution of optimum common-electrode electric potentials calculated by the flicker minimum value determining method over the line perpendicular to the video signal lines which distribution varies in accordance with distances from the scanning signal line driving circuit, and (ii) distribution of optimum common-electrode electric potentials calculated by the flicker minimum value determining method over the line perpendicular to the video signal lines which distribution varies in accordance with storage capacitor signals inputted from two ends of the liquid crystal display device. Thus, such liquid crystal display device can offset the distributions of optimum common-electrode electric potentials (i) and (ii).

It is preferable that the video signal line driving circuit of the present invention include an offset adder circuit that stores an offset value with which to offset the distribution of optimum common-electrode electric potentials over the line perpendicular to the video signal lines.

With the configuration, it is only necessary that the predetermined offset values be stored. Such simple configuration can deal with influence of feed-through over optimum common-electrode electric potentials calculated by the flicker minimum value determining method and makes it possible to offset the distribution of the optimum common-electrode electric potentials over the line perpendicular to the video signal lines.

In order to attain the object, a liquid crystal display device of the present invention is a liquid crystal display device, including: video signal lines and scanning signal lines, which intersect with one another: a video signal line driving circuit for driving the video signal lines: a scanning signal line for driving the scanning signal lines: and a storage capacitor signal source for supplying storage capacitor signals, from two ends of the liquid crystal display device, in lines parallel with the scanning signal lines, wherein: the video signal line driving circuit varies, based on distribution of optimum common-electrode electric potentials over a line perpendicular to the video signal lines, which optimum common-electrode electric potentials are calculated by a flicker minimum value determining method, an electric potential of an output signal in accordance with to which video signal line the output signal is to be outputted; and the electric potential of the output signal is greater as the video signal line is farther from an approximate center of a display surface of the liquid crystal display device.

Note that the distribution of optimum common-electrode electric potentials over a line perpendicular to the video signal lines, which optimum common-electrode electric potentials are calculated by the flicker minimum value determining method, is based on feed-through electric potentials by signal delay of a scanning signal and/or feed-through electric potentials by CS (storage capacitor) electric potentials.

In a liquid crystal display device which receives, from two ends of it, storage capacitor signals supplied from a storage capacitor signal source used in the liquid crystal display device, an optimum common-electrode electric potential calculated by the flicker minimum value determining method is smaller as a common electrode is farther from an approximate center of a display surface of the liquid crystal display deice toward at least one end of the display surface. Taking this into account, it is arranged so that an electric potential of an output signal is greater as a video signal to be applied with the output signal is farther from the approximate center of the display surface of the liquid crystal display device toward at least one end of the display surface. This makes is possible to offset the distribution of optimum common-electrode electric potentials over the line perpendicular to the video signal lines, which optimum common-electrode electric potentials are calculated by the flicker minimum value determining method. Thus, with the arrangement, it is possible to offset the distribution of optimum common-electrode electric potentials over the line perpendicular to the video signal lines, which optimum common-electrode electric potentials are calculated by the flicker minimum value determining method.

In order to attain the object, a liquid crystal display device of the present invention is a liquid crystal display device, including: video signal lines and scanning signal lines, which intersect with one another; a video signal line driving circuit for driving the video signal lines; a scanning signal line driving circuit for driving the scanning signal lines; and a storage capacitor signal source for supplying storage capacitor signals, from two ends of the liquid crystal display device, in lines parallel with the scanning signal lines, wherein: the video signal line driving circuit varies, based on distribution of optimum common-electrode electric potentials over a line perpendicular to the video signal lines, which optimum common-electrode electric potentials are calculated by a flicker minimum value determining method, an electric potential of an output signal in accordance with to which video signal line the output signal is to be outputted; and the electric potential of the output signal is greater as the video signal line is farther from a certain position of a display surface of the liquid crystal display device, which certain position of the display surface is closer to the scanning signal line driving circuit than an approximate center of the display surface to the scanning signal line driving circuit.

Note that the distribution of optimum common-electrode electric potentials over a line perpendicular to the video signal lines, which optimum common-electrode electric potentials are calculated by the flicker minimum value determining method, is based on feed-through electric potentials by signal delay of a scanning signal and/or feed-through electric potentials by CS (storage capacitor) electric potentials.

An optimum common-electrode electric potential calculated by the flicker minimum value determining method is greater as a distance from the scanning signal line driving circuit used in the liquid crystal display device is greater.

Also, in a liquid crystal display device which receives, from two ends of it, storage capacitor signals supplied from a storage capacitor signal source used in the liquid crystal display device, an optimum common-electrode electric potential is smaller as a common electrode is farther from an approximate center of a display surface of the liquid crystal display device toward at least one end of the display surface. Thus, taking into account distributions of optimum common-electrode electric potentials calculated by the flicker minimum value determining method over a line perpendicular to the video signal lines which distributions arise under influences in such cases, it is arranged so that an electric potential of an outputs signal of the video signal line driving circuit is greater as a video signal line to be applied with the output signal is farther from a certain position of a display surface of the liquid crystal display device toward at least one end of the display surface, which certain position of the display surface is closer to one end of the display surface than an approximate center of the display surface to the end. By this, it is possible to offset the distributions. Thus, the liquid crystal displays which employ the arrangement can deal with (i) distribution of optimum common-electrode electric potentials calculated by the flicker minimum value determining method over the line perpendicular to the video signal lines which distribution varies in accordance with distances from the scanning signal line driving circuit, and (ii) distribution of optimum common-electrode electric potentials calculated by the flicker minimum value determining method over the line perpendicular to the video signal lines which distribution varies in accordance with storage capacitor signals inputted from two ends of the liquid crystal display device. Thus, such liquid crystal display device can offset the distributions of optimum common-electrode electric potentials (i) and (ii).

It is preferable that the liquid crystal display device of the present invention be configured so that the scanning signal line driving circuit includes an offset adder circuit that stores an offset value with which to offset the distribution of optimum common-electrode electric potentials over the line perpendicular to the video signal lines.

With the configuration, it is only necessary that the predetermined offset values be stored. Such simple configuration can deal with influence of feed-through over optimum common-electrode electric potentials calculated by the flicker minimum value determining method and makes it possible to offset the distribution of the optimum common-electrode electric potentials over the line perpendicular to the video signal lines.

As described above, the video signal line driving circuit of the present invention is the video signal line driving circuit for driving video signal lines formed in a liquid crystal display device, wherein: the video signal line driving circuit varies, based on distribution of optimum common-electrode electric potentials over a line perpendicular to the video signal lines, which optimum common-electrode electric potentials are calculated by the flicker minimum value determining method, an electric potential of an output signal in accordance with to which video signal line the output signal is to be outputted; and the electric potential of the output signal is greater as the video signal line is farther from an approximate center of a display surface of the liquid crystal display device toward at least one end of the display surface.

Further, as described above, the video signal line driving circuit of the present invention is the video signal line driving circuit for driving video signal lines formed in a liquid crystal display device, wherein: the video signal line driving circuit varies, based on distribution of optimum common-electrode electric potentials over a line perpendicular to the video signal lines, which optimum common-electrode electric potentials are calculated by the flicker minimum value determining method, an electric potential of an output signal in accordance with to which video signal line the output signal is to be outputted; and electric potential of the output signal is greater as the video signal line is farther from a certain position of a display surface of the liquid crystal display device toward at least one end of the display surface, which certain position of the display surface is closer to one end of the display surface than an approximate center of the display center to the one end of the display surface.

As described above, the liquid crystal display device of the present invention is the liquid crystal display device, including: video signal lines and scanning signal lines, which intersect with one another; a video signal line driving circuit for driving the video signal lines; a scanning signal line driving circuit for driving the scanning signal lines; and a storage capacitor signal source for supplying, from two ends of the liquid crystal display device, storage capacitor signals, in lines parallel with the scanning signal lines, wherein: the video signal line driving circuit varies, based on distribution of optimum common-electric potentials over a line perpendicular to the video signal lines, which optimum common-electrode electric potentials are calculated by the flicker minimum value determining method, an electric potential of an output signal in accordance with to which video signal line the output signal is to be outputted; and the electric potential of the output signal is greater as the video signal is farther from an approximate center of a display surface of the liquid crystal display device.

Further, as described above, the liquid crystal display device of the present invention is the liquid crystal display device, including: video signal lines and scanning signal lines, which intersect with one another; a video signal line driving circuit for driving the video signal lines; a scanning signal line driving circuit for driving the scanning signal lines; and a storage capacitor signal source for supplying, from two ends of the liquid crystal display device, storage capacitor signals in lines parallel with the scanning signal lines, wherein the video signal line driving circuit varies, based on distribution of optimum common-electrode potentials over a line perpendicular to the video signal lines, which optimum common-electrode potentials are calculated by the flicker minimum value determining method, an electric potential of an output signal in accordance with to which video signal line the output signal is to be outputted; and the electric potential of the output signal is greater as a distance from a certain position of a display surface of the liquid crystal display device, which certain position is closer to the scanning signal line driving circuit than an approximate center of the display surface to the scanning signal line driving circuit, is greater.

In other words, the video signal line driving circuit of the present invention is a video signal line driving circuit for driving video signal lines formed in a liquid crystal display device, wherein: the video signal line driving circuit varies, by using a predetermined offset value, a center electric potential of an output signal in accordance with to which video signal line the output signal is to be outputted; and the predetermined offset value is set so that the center electric potential is greater as the video signal line is farther from an approximate center of a display surface of the liquid crystal display device toward at least one end of the display surface.

Also, the video signal line driving circuit of the present invention can be said as a video signal line driving circuit for driving video signal lines formed in a liquid crystal display device, wherein: the video signal line driving circuit varies, by using a predetermined offset value, a center electric potential of an output signal in accordance with to which video signal line the output signal is to be outputted; and the predetermined offset value is set so that the center electric potential of the output signal is greater as the video signal line is farther from a certain position of a display surface of the liquid crystal display device toward at least on end of the display surface, which certain position of the display surface is closer to one end of the display surface than an approximate center of the display surface to the one end of the display surface.

The liquid crystal display device of the present invention can be said as a liquid crystal display device, including: video signal lines and scanning signal lines, which intersect with one other; a video signal line driving circuit for driving the video signal lines, the video signal line driving circuit varying, by using a predetermined offset value, a center electric potential of an output signal in accordance with to which video signal line the output signal is to be outputted; a scanning signal line driving circuit for driving the scanning signal lines; and a storage capacitor signal source for supplying scanning signals, from two ends of the liquid crystal display device, in lines parallel with the scanning signal lines, the predetermined offset value being set so that the center electric potential of the output signal is greater as the video signal line is farther from an approximate center of a display surface of the liquid crystal display device is greater.

Also, the liquid crystal display device of the present invention can be said as a liquid crystal display device, including: video signal lines and scanning signal lines, which intersect with one other; a video signal line driving circuit for driving the video signal lines, the video signal line driving circuit varying, by using a predetermined offset value, a center electric potential of an output signal in accordance with to which video signal line the output signal is to be outputted; a scanning signal line driving circuit for driving the scanning signal lines; and a storage capacitor signal source for supplying scanning signals, from two ends of the liquid crystal display device, in lines parallel with the scanning signal lines, the predetermined offset value being set so that the center electric potential is greater as the video signal line is farther from a certain position of a display surface of the liquid crystal display device, which certain position of the display surface is closer to the scanning signal line driving circuit than an approximate center of the display surface to the scanning signal line driving circuit.

Thus, it is possible to provide a video signal line driving circuit and a liquid crystal display device, each being capable of preventing: in-plane flicker which arises due to distribution of optimum common-electrode electric potentials varying in accordance with distances from the scanning signal line driving circuit; and in-plane flicker which arises due to shifts varying in accordance with distances from the scanning signal line driving circuit and CS trunk line resistance.

For a fuller understanding of the nature and advantages of the invention, reference should be made to the ensuing detailed description taken in conjunction with the accompanying drawings.

### BRIEF DESCRIPTION OF DRAWINGS

FIG. 1 is a graph showing a relationship between a center electric potential of a source driver output and a distance from a gate driver output section, in accordance with a present embodiment.

FIG. 2 is a block diagram showing an internal configuration of a source driver in accordance with the present embodiment.

FIG. 3 is a view showing a pixel model to which storage capacitor signals are inputted from one end.

FIG. 4 shows timings and electric potentials of a source driver signal, a gate driver signal, and a CS signal which are inputted to the pixel model shown in FIG. 3.

FIG. 5 is a waveform chart showing (i) a TFT drain electric potential, a gate signal, and a CS signal in a pixel located closer to a CS input terminal and (ii) a TFT drain electric potential, a gate signal, and a CS signal in a pixel located farther from the CS input terminal, both of which (i) and (ii) arise in pSPICE simulation using models shown in FIGS. 3 and 4.

FIG. 6 is a graph showing distribution of optimum common electric potentials over a line perpendicular to source signal lines, which distribution arises due to feed-through electric potentials by storage capacitor electric potentials in a case where a storage capacitor signal is inputted from one end.

FIG. 7 is a view showing a pixel model to which storage capacitor signals are inputted from two ends.

FIG. 8 shows timings and electric potentials of a source driver signal, a gate driver signal, and a CS signal which are inputted to the pixel mode shown in FIG. 7.

FIG. 9 is a waveform chart showing (i) a TFT drain electric potential and a CS signal in a pixel located closer to a CS input terminal and (ii) a TFT drain electric potential and a CS signal in a pixel located farther from the CS input terminal, both of which (i) and (ii) arise in pSPICE simulation using modes shown in FIGS. 7 and 8.

FIG. 10 is a graph showing distribution of optimum common electric potentials over a line perpendicular to source signal lines, which distribution arises due to field-though electric potentials by storage capacitor electric potentials in a case where storage capacitor signals are inputted from two ends.

FIG. 11 is a graph showing distribution of optimum common electric potentials over a line perpendicular to source signal lines, which distribution arises due to (i) feed-through electric potentials by storage capacitor electric potentials and (ii) feed-through electric potentials by signal delay of a gate signal in a case where the storage capacitor signals are inputted from two ends.

FIG. 12 is a flow chart of an image data processing section shown in FIG. 2.

FIG. 13 is a view showing an internal configuration of a gradation reference voltage generating circuit.

FIG. 14 is a graph showing a reference example of an output voltage obtained without adjusting a center electric potential of the source driver of the present embodiment.

FIG. 15 is a graph showing an output voltage obtained by adjusting a center electric potential of the source driver of the present embodiment.

FIG. 16 is a graph showing center electric potentials of source drivers for offsetting the distribution of optimum common electric potentials over a line perpendicular to source signal lines, which distribution arises due to feed-electric potentials by signal delay of a gate signal.

FIG. 17 is a graph showing center electric potentials of source drivers for offsetting distribution of optimum common electric potential over a line perpendicular to source signal lines, which distribution arises due to feed-through electric potentials by storage capacitor electric potentials in a case where storage capacitor signals are inputted from one end.

FIG. 18 is a graph showing center electric potentials of source drivers for offsetting distribution of optimum common electric potentials over a line perpendicular to source signal lines, which distribution arises due to feed-through electric potentials by storage capacitor electric potentials in a case where storage capacitor signals are inputted from two ends.

FIG. 19 is a graph showing distribution of optimum common electric potentials over line perpendicular to source signal lines, which distribution arises due to (i) feed-through electric potentials by storage capacitor electric potentials and (ii) feed-through electric potentials by signal delay of a gate signal in a case where storage capacitor signals are inputted from one end.

FIG. 20 is a graph showing center electric potentials of source drivers for offsetting distribution of optimum common electric potentials over a line perpendicular to source signal lines, which distribution arises due to (i) feed-through electric potentials by storage capacitor electric potentials and (ii) feed-through electric potentials by signal delay of a gate signal in a case where storage capacitor signals are inputted from one end.

FIG. 21 is a view showing a configuration of a conventional active matrix liquid crystal display.

FIG. 22 is a waveform chart showing a driving signal at a point A in FIG. 21.

FIG. 23 is a waveform chart showing a driving signal a point B in FIG. 21.

FIG. 24 is a graph showing distribution of optimum common electric potential over a line perpendicular to source signal lines, which distribution arises due to feed-through electric potentials by feed-through electric potentials by signal delay of a gate signal.

FIG. 25 is a view for explaining a problem concerning conventional Cgd gradation.

### DESCRIPTION OF EMBODIMENTS

In the present Specification, terms “feed-through voltage” and “field-through electric potential” are used interchangeably with each other. Both a feed-through voltage and a field-through electric potential are an electric potential that causes a drain electric potential of a TFT to be shifted to a shift direction of a gate signal. An optimum common electric potential is adjusted by a flicker minimum value determining method. As disclosed in Patent Literature 5, the flicker minimum value determining method has been known as a method for evaluating and determining a symmetric property. By the flicker minimum value determining method, an optical response waveform is observed while a display pattern in which flicker is most noticeable is being displayed, and a common electric potential with which a frequency component of the optical response waveform is smallest (in many cases, 30 Hz) is determined as an optimum value.

The optimum common electric potential thus determined by the flicker minimum value determining method is actually optimum in a case where an average electric potential of a “TFT drain electric potential” and that of a “common electric potential” are identical with each other. Taking influence of the feed-through voltage into consideration, the optimum common electric potential is equivalent to “(a center electric potential of a source driver output signal)—(a field-through electric potential)”. The word “output” in the “output center electric potential” indicates an output signal of the source driver (video signal line driving circuit). Since the source driver is normally driven by an AC signal having a duty ratio of 50%. The word “center electric potential” indicates an average electric potential of a high amplitude level and a low amplitude level of the source driver output signal.

The present invention is to improve a problem of in-plane flicker by offsetting distribution of optimum common electric potentials. The inventors of the present invention paid attention to a fact that the in-plane flicker is influenced by not only a feed-through electric potential caused by signal delay of a gate signal but also by a feed-through electric potential caused by a CS (storage capacitor) electric potential. The following description therefore first discusses a mechanism on which the in-plane flicker arises due to a storage capacitor electric potential, before discussing an embodiment of the present invention. Note that the storage capacitor signal can be inputted from one or two ends of a liquid crystal display device. As such, the following description discusses the mechanism as to the two different cases.

description discusses the mechanism by using a simplified panel model in which a pixel

(Mechanism in a Case in which Storage Capacitor Signal is Inputted from One End)

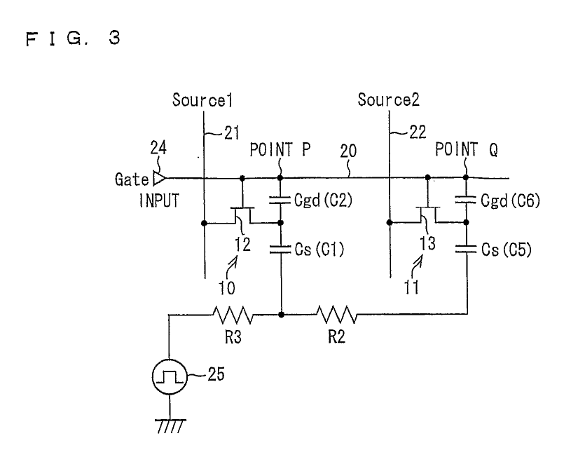

The following model is as shown in FIG. 3. In this case, only influence of CS capacitance (pixel storage capacitance; C1 and C5) and Cgd capacitance (gate-drain parasitic capacitance; C2 and C6) are taken into consideration. In FIG. 3, a CS signal input section (CS input terminal) 25 and a gate input 24 are provided at a same end, and a gate signal line 20 intersects with source signal lines 21 and 22, the source signal line 21 being closer to the CS signal input section 25 whereas the source signal line 22 being farther from it. The source signal line 21 is connected to a pixel section 10 which includes a TFT 12, a CS capacitance C1, and a Cgd capacitance C2. The source signal line 22 is connected to a pixel section 11 which includes a TFT 13, a CS capacitance C5, and a Cgd capacitance C6. The CS capacitance C1 of the pixel section 10 is connected to the Cs signal input section 25 via a CS trunk line resistor R3, and the CS capacitance C5 of the pixel section 11 is connected to the CS signal input section 25 via a CS trunk line resistor R3 and a CS bus line resistor R2. The CS trunk line resistor R3 is constituted by a storage capacitor (CS) signal line provided outside of a display region on a substrate. The CS trunk line resistor R3 has a relatively smaller resistance. On the other hand, the CS bus line resistor R2 is constituted by a storage capacitor (CS) signal line provided within the display region on the substrate. The CS bus line resistor R2 has a relatively greater resistance and has influence on distribution of optimum common electric voltages.

An operation mechanism of the simplified panel model is examined under such setting that the simplified panel model with the resistances and the capacitances receives driving signals (source signal, gate signal, CS signal) which are equivalent to driving signals for driving a real liquid crystal panel.

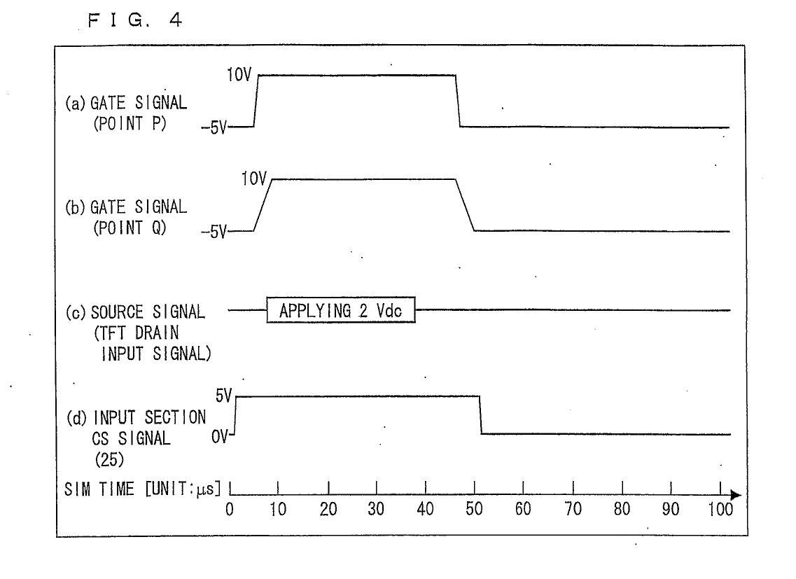

Waveforms of the driving signals are as shown in FIG. 4. FIG. 4(a) shows a gate waveform of a point P of the gate signal line 20 at which the gate signal line 20 and the Cgd capacitance C2 are connected to each other. FIG. 4(b) shows a gate waveform of a point Q of the gate signal line 20 at which the gate signal line 20 and the Cgd capacitance C6 are connected to each other. As shown in FIGS. 4(a) and (b), a signal waveform (gate waveform) in the pixel section 10 is different from that in the pixel section 11 due to signal delay of a gate signal. Specifically, the gate waveform of the point P indicates it takes 1 μs for the gate signal to rise or fall, while the gate waveform at the point Q indicates it takes 4 μs to do so.

FIG. 4(c) shows a voltage which is applied to the source signal line 21 and a drain of the TFT 12 as well as to the source signal line 22 and a drain of the TFT 13. As shown in FIG. 4(c), a DC voltage of 2V is applied during a time period which starts at 8 μs and ends at 38 μs. FIG. 4(d) shows a CS signal waveform of a CS signal input end. The CS signal waveform is of a rectangular wave that oppositely shifts at a cycle of 50 μs.

SPICE simulation is performed in which the pixel model shown in FIG. 3 externally receives the signal shown in FIG. 4. A result of the SPICE simulation is shown in FIG. 5. FIG. 5 is a waveform chart showing: a TFT drain electric potential, a gate electric potential, and the CS signal in a pixel located closer to a CS input terminal; and a TFT drain electrode, a gate electric potential, and a CS signal in a pixel located farther from the CS input terminal.

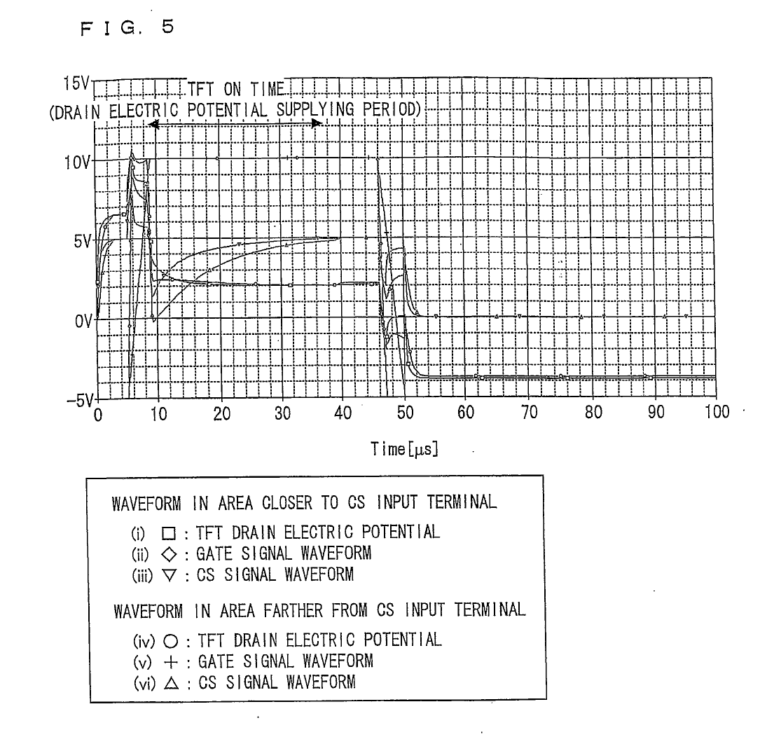

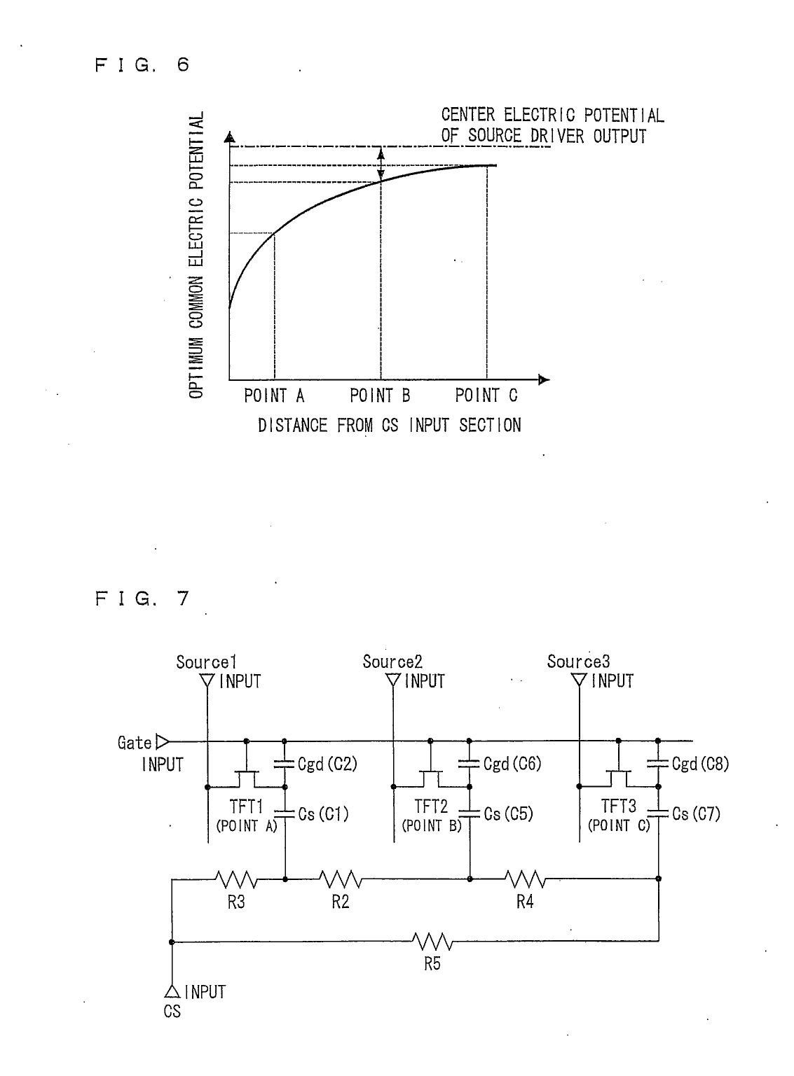

In the pixel located farther from the CS input terminal, a waveform of a CS signal (vi) is rounded more than a waveform of a CS signal (iii) in the pixel located closer to the CS input terminal, due to influence of the CS bus line resistor R2. During a period when TFTs are turned ON, a source driver output is applied to drain electric potentials of the TFTs so that signals (i) and (iv), which correspond to the respective drain electric potentials of the TFTs, are shifted closer to 2 Vdc. When the TFTs are turned OFF as a gate signal falls off, the signals (1) and (iv), which correspond to the drain electric potentials of the TFTs, are shifted lower via corresponding Cgd capacitances (gate-drain parasitic capacitances) by feed-through. As described by these, a CS electric potential residing on the other side of Cgd capacitance is affected as well. Note that a CS electric potential and a TFT drain electric potential in the pixel located closer to the CS input terminal are pulled in by a smaller degree and recover more quickly as compared to a CS electric potential and a TFT drain electric potential in the pixel located farther from the CS input terminal. However, due to influence of CS bus line resistor R2, the TFT drain electric potential (iv) in the pixel located farther from the CS input terminal converges at a higher level as compared to the TFT drain electric potential (i) in the pixel located closer to the CS input terminal. Therefore, distribution of optimum common-electrode electric potentials over a line perpendicular to the source signal line 21, which distribution arises in a case where storage capacitor signals are inputted from one end of the liquid crystal display device and which optimum common-electrode electric potentials are calculated by the flicker minimum value determining method, is such distribution in which an optimum common electric potential of a common electrode provided farther from the CS input terminal is greater as shown in FIG. 6.

(Mechanism in a Case where Storage Capacitor Signal is Inputted from Two Ends)

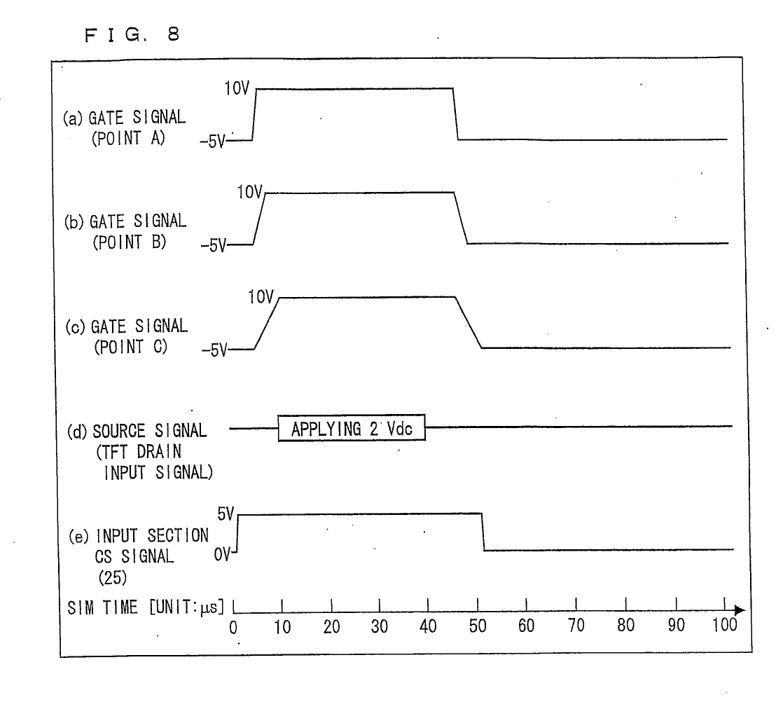

Similarly to a mechanism of CS bus line influence which arises in the case where the storage capacitor signals are inputted from one end, a mechanism of CS bus line influence which arises in a case where storage capacitor signals are inputted from two ends can be simulated. In simulation, a model as shown in FIG. 7 receives driving signals as shown in FIG. 8. A result of the simulation is as shown in FIG. 9. In the model shown in FIG. 7, an A-point pixel, a B-point pixel, and a C-point pixel are arranged in this order from a gate driver. The A-point pixel is located at a left end of a liquid crystal panel, the B-point pixel is located in center of the liquid crystal panel, and the C-point pixel is located at a right end of the liquid crystal panel. In FIGS. 7, R3 and R5 are CS trunk line resistors, and R2 and R4 are CS bus line resistors. The CS bus line resistors R2 and R4 are constituted by a storage capacitor (CS) signal line provided within a display region on a substrate. The CS bus line resistors R2 and R4 have relatively greater resistances and have influence on distribution of optimum counter voltages. On the other hand, the CS trunk line resistors R3 and R5 are constituted by respective storage capacitor (CS) lines provided outside of the display region on the substrate. The CS trunk line resistors R3 and R5 have relatively smaller resistances.

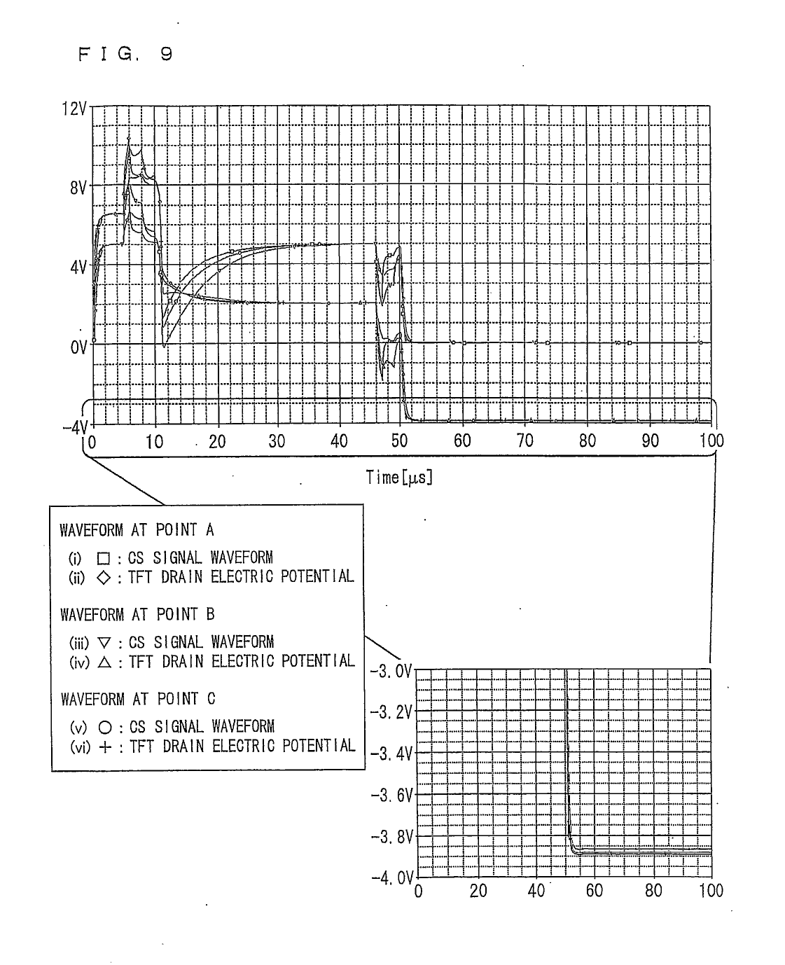

In the simulation, among gate signals outputted to respective gate signal lines, fall-off times of gate signals are differently set depending on the location of pixel. However, even if fall-off time of the gate signals are set equal with one another, distribution of drain electric potentials of TFTs will be same. As shown in the result of the simulation, in the B-point pixel section, a CS signal waveform is rounded most, and the TFT drain electric potential is the highest. Distribution of optimum electric potentials to drain electric potentials of TFTs over a line perpendicular to the source signal lines is of a bell curve, as shown in FIG. 10. Note that a signal difference is lesser in a case where storage capacitor signals are inputted from two ends, than in a case where the storage capacitor signals are inputted from one end.

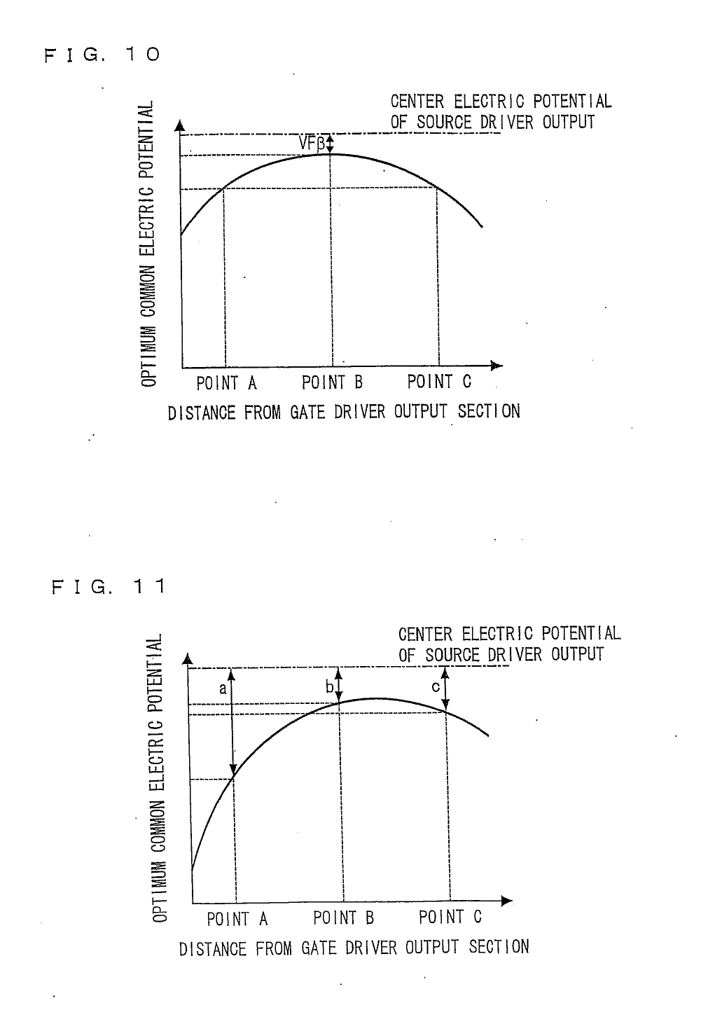

FIG. 10 shows distribution of optimum common-electrode electric potentials over a line perpendicular to the source signal lines, which distribution arises under only influence of CS bus lines (via which storage capacitor signals are inputted from two ends). FIG. 11 shows distribution of optimum common-electrode electric potentials over a line perpendicular to the source signal lines, which distribution arises under influence of CS bus lines (via which storage capacitor signals are inputted from two ends) and influence of signal delay of a gate signal.

### Configuration of Embodiment

An embodiment of the present invention is described below. A characteristic configuration of the present invention is an offset adder circuit (which is later described) in a source driver. A feature of the present embodiment is to offset, by the offset adder circuit, distribution of optimum common electric potentials over a line perpendicular to the source signal lines. Specifically, means of the present embodiment for offsetting the distribution of optimum common electric potentials over the line perpendicular to the source signal lines includes three offset patterns. In a first one of the three offset patterns, the offset adder circuit offsets distribution of optimum common electric potentials over a line perpendicular to the source signal lines which distribution arises due solely to feed-through electric potentials by signal delay of a gate signal. In a second one of the three offset patterns, the offset adder circuit offsets distribution of optimum common electric potentials over a line perpendicular to the source signal lines which distribution arises due solely to feed-through electric potentials by CS electric potentials. In a third one of the three offset patterns, the offset adder circuit offsets distribution of optimum common electric potentials over a line perpendicular to the source signal lines which distribution arises due to the feed-through electric potentials by signal delay of a gate signal and the feed-through electric potentials by CS electric potentials. Note that signal line driving circuits (source drivers) for realizing the respective three offset patterns are configured identically with one another, except that the offset values stored in the offset adder circuits are different. Although it is described above that the offset values are stored in the offset adder circuits, the present embodiment is not limited to this. Alternatively, the offset values can be stored in another memory than the offset adder circuits, and read out by the offset adder circuits.

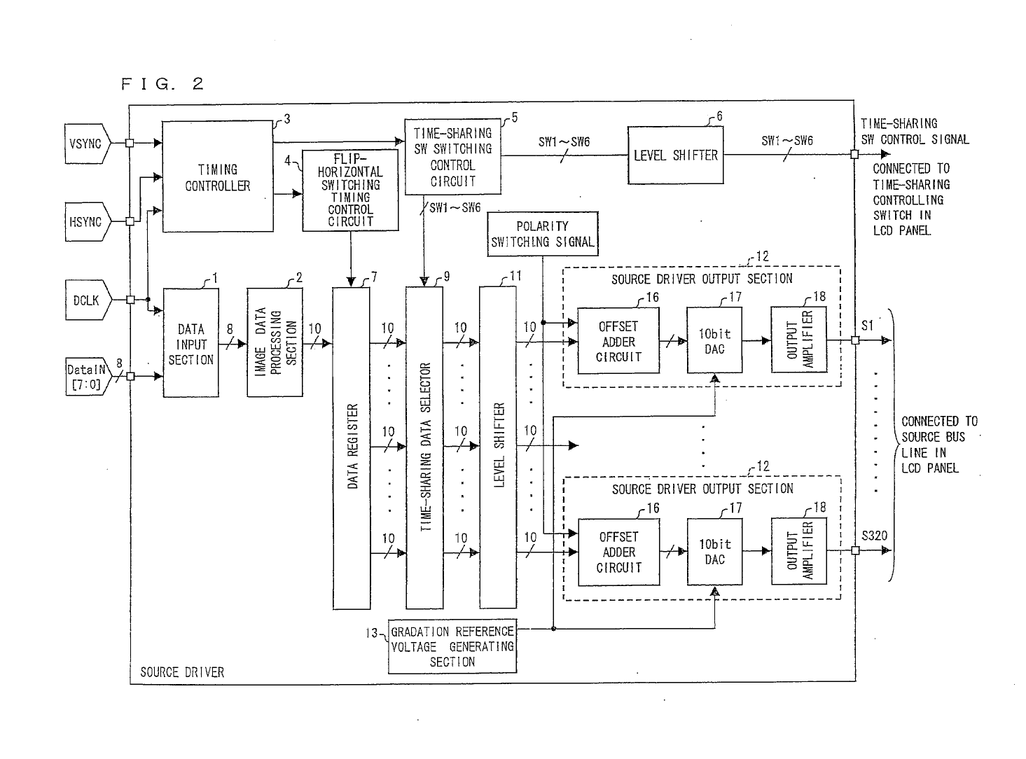

As shown in FIG. 2, the source driver includes a data input section 1, an image data processing section 2, a timing controller 3, a flip-horizontal switching and timing control circuit 4, a time-sharing SW switching control circuit 5, a level shifter 6, a data register 7, a time-sharing data selector 9, a level shifter 11, a plurality of source driver output sections 12, and a gradation reference voltage generating circuit 13.

The source driver receives, as input signals, 8-bit video data input DataIN, a vertical synchronization signal VSYNC, a horizontal synchronization signal HSYNC, and a data read-out clock input DCLK. In a case where the 8-bit video input is inputted, 2⁸ gradations, i.e., 256 gradations, can be displayed.

The timing controller 3 receives VSYNC, HSYNC, and DCLK, and, in response, controls the flip-horizontal switching and timing control circuit 4 and the time-sharing SW switching control circuit 5.

The video data are synchronized with DCLK, based on HSYNC, and inputted to the data input section 1 sequentially in a display order. Then, the data input section 1 transmits the video data to the image data processing section 2.

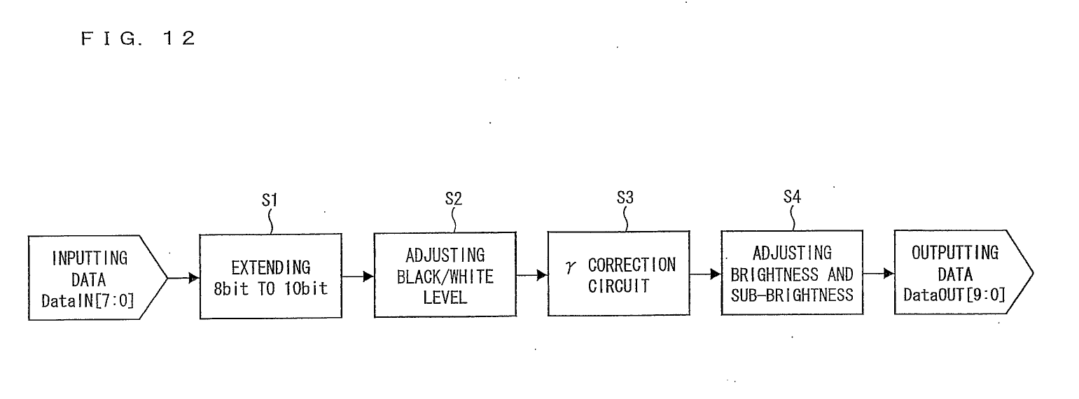

FIG. 12 shows a process flow of the image data processing section 2. The image data processing section 2 performs data conversion through the following steps. At first, the image data processing section extends the video data to 10-bit data (i.e., shifting up the video data by 2-bit; S1). Then, the image data processing section 2 adjusts black/white levels of the 10-bit data, i.e., adds corresponding offset values to the 10-bit data (S2). After this, the image processing section 2 adjusts a γ characteristic of display gradation (S3). A normal display has an input gradation/display brightness characteristic being set to an index of 2.2, whereas a gradation reference voltage generating circuit 13 (which is later described) has a linear gradation/voltage characteristic. As such, even if the gradation/voltage characteristic is synthesized with the input gradation/display brightness characteristic of the normal panel, an input gradation/display brightness characteristic of an index of 2.2 is not necessarily obtained. Therefore, it is necessary that data conversion be performed. The data conversion to be performed by a γ circuit (which is not illustrated) is normally computation using a conversion equation or conversion using a conversion table called LOOK UP TABLE. After the process at S3, a brightness and sub-brightness adjusting section (which is not illustrated) performs black to white amplitude adjustment (S4) for each of RGB display colors. Thereafter, data corresponding to 10-bit are outputted.

The data thus processed by the image data processing section 2 are stored in the data register 7. The data register 7 has a capacity to store display data for one line of pixels. For example, in a display having resolution equivalent to VGA, a data resister 7 has a capacity to store display data for 640×RGB=1920 pixels. The data register 7 stores the data sequentially in display order. However, the present embodiment is not limited to this. In a case where a flip-horizontal function is equipped, then the data register 7 stores the data in reverse order.

There is a case that a switching SW (switch) is provided within a panel so that time-sharing driving for switching outputs in a time-sharing manner can be performed. This realizes a reduction of the number of the outputs of the source driver. For example, in a case where the number of time-sharing is six, it is possible that six different source lines be driven by switching an output between six outputs during one line period.

A time-sharing data selector 9 selects, from a group of six pieces of data stored in the data register 7, data in accordance with switching timing of a time-sharing switching SW (switch) (which is not shown in the drawing). Control of the time-sharing switching SW is performed by a time-sharing SW switching control circuit 5. A voltage level of the data thus selected is adjusted by the level shifter 6, and after this, the data thus selected are transferred to the source driver output sections 12.

Each of the source driver output section 12 has one output circuit for each source driver output terminal (output). As such, for example, in a case where the source driver has 320 output terminals (outputs), the source driver output sections 12 have 320 output circuits. Each output circuit includes: a DAC circuit 17 for switching a reference voltage in accordance with data equivalent to 10-bit data varying from 0 to 1023; an output amplifier 18 sufficiently operable to drive a corresponding one of the source bus lines formed in the liquid crystal panel; and an offset adder circuit 16. The reference voltage is generated in the gradation reference voltage generating circuit 13. FIG. 13 shows a gradation reference voltage generating circuit 13 of resistor DAC type.

As shown in FIG. 13, in a case where gradation reference voltages for n gradation are represented by Vn (n=0, . . . 1023), the gradation reference voltage generating circuit 13 of resistor DAC type generates Vn by resistance ladders R1 through R1023 of between reference voltages V0 and V1023. In the description, resistance values between respective corresponding gradations are identical with one another, although the present embodiment is not limited to this. As in the case with the present embodiment, many liquid crystal displays are driven by reversed-polarity driving.

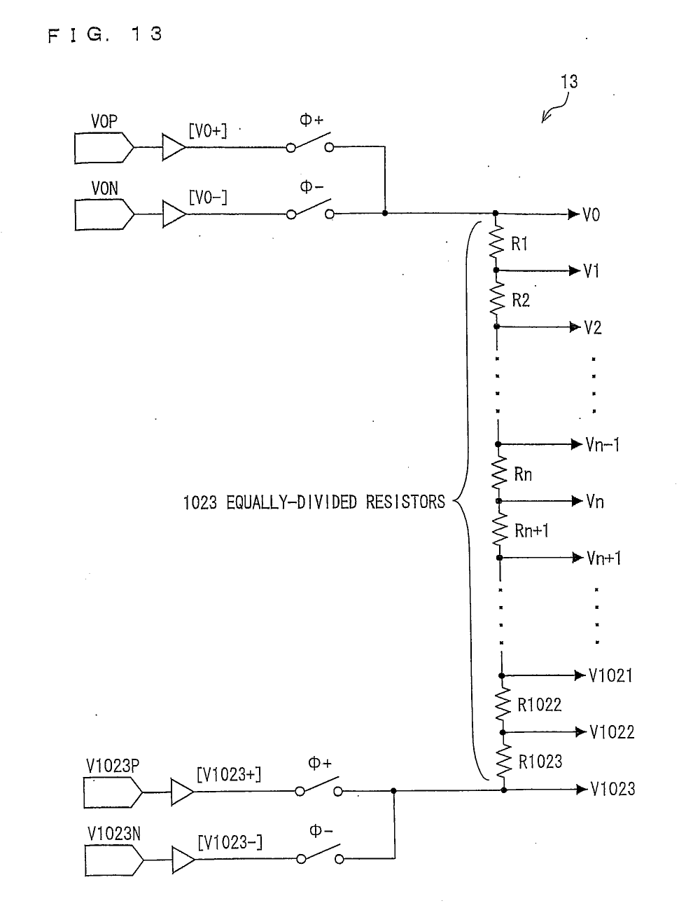

In a case where a positive reference voltage for n gradation is VnP and a negative reference voltage for n gradation is VnN, VnP is generated by resistance ladders of between V0P and V1023P, and VnN is generated by resistance ladders of between V0N and V1023N. In the present embodiment, a cycle of reversal of a polarity is one horizontal period (1H reverse driving). Also, same resistor ladders are used for generation of both positive and negative reference voltages. For this, only polarities of voltages V0 and V1023 at respective ends are switched in accordance with a polarity switching signal Φ. The gradation reference voltages thus generated are varied at a constant rate according to Data 0 to Data 1023, and output voltages to be generated by this are as shown in FIG. 14.

In a normal source driver, source driver outputs for causing display of same gradation levels are of identical voltages. For example, source driver voltages each for causing display of “24 gradation” are outputted by switching V24P and V24N in accordance with the polarity-switching signal Φ, as shown in FIG. 14.

The most important aspect of the present embodiment is described below.

In the present embodiment, as shown in FIG. 2, each source driver output section 12 includes an offset adder circuit 16 provided upstream of 10-bit DAC. The offset adder circuit 16 stores a predetermined offset addition value which varies in accordance with to which source signal line a corresponding source driver output is outputted. The offset adder circuit 16 switches its operation between addition and extraction in response to a polarity switching signal Φ.

This is described in more detail as follows. In case of receiving a positive polarity switching signal Φ, the offset adder circuit 16 extracts the offset addition value from an output value. On the other hand, in a case of receiving a negative polarity switching signal Φ, the offset adder circuit 16 adds the offset addition value to an output value.

Although it is merely illustrative, the following description discusses a change of output by using a specific numeric example. Let it be assumed that in the gradation reference voltage generating circuit, a reference voltage V0P=4.596 V, a reference voltage V1023P=0.500 V, a reference voltage V0N=0.500, and a reference voltage V1023N=4.596 V. In this case, an amount by which a reference voltage is changed for each gradation is:

4[mV] (|Vn+1P−VnP|=|Vn+1N−VnN|).

Let it be assumed that a source driver output section 12 has an offset addition value of “4”. In this case, if the source driver output section 12 receives the positive polarity switching signal Φ, an output value for causing display of “24 gradation” is extracted by “4 gradation” so as to be equivalent to “an output value for causing display of 20 gradation”. On the other hand, in a case where the source driver output section 12 receives the negative polarity switching signal Φ, an output value for causing display of “24 gradation” is added with “4 gradation” so as to be equivalent to “an output value for causing display of 28 gradation”.

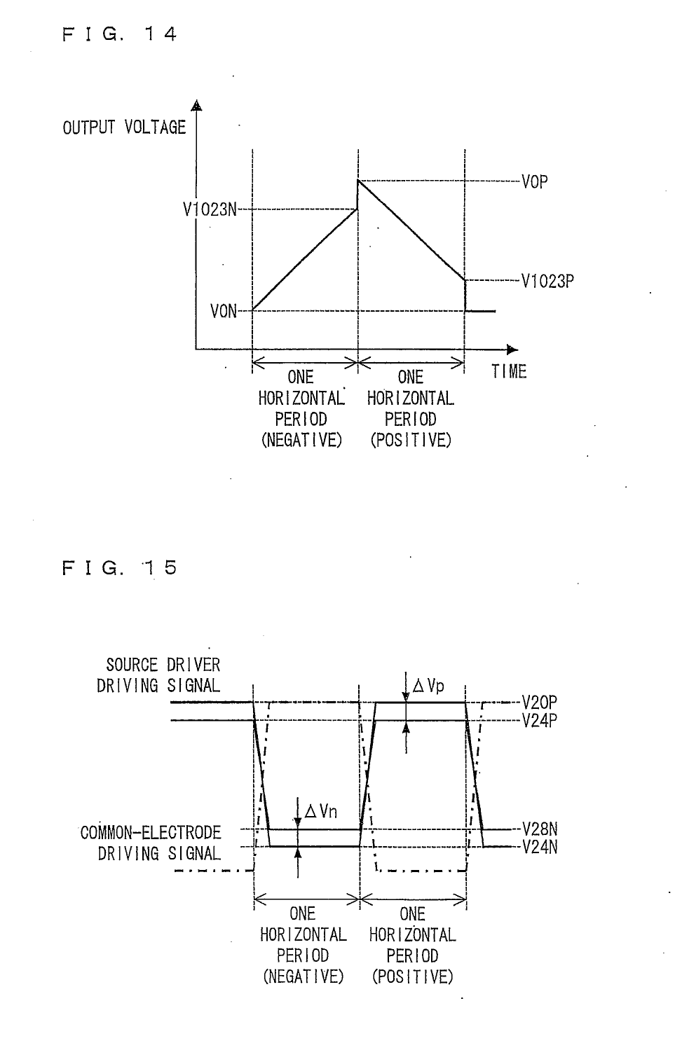

A relationship between an output value (output voltage) and time in this case is as shown in FIG. 15. As such, in a case where the source driver output section 12 receives the negative polarity switching signal Φ, a resultant output voltage is higher than an output voltage as would be obtained in a case where an offset addition value is 0 (conventional case), by an electric potential difference:

ΔVnP=V20P−V24P=4.516−4.500=0.016 [V].

On the other hand, in a case where the source driver output section 12 receives the positive polarity switching signal Φ, a resultant output voltage is higher than an output voltage as would be obtained in the conventional case, by an electric potential difference:

ΔVp=V20P−V24P=4.516−4.500=0.016 [V].

Therefore, a center value of a source driver output electric potential of the source driver output section 12 can be increased by 16 [mV], irrespective of a polarity of the polarity switching signal Φ. Thus, by setting the center value of the source driver output electric potential in accordance with a distance from the gate driver to a source signal line to which the source driver output is outputted, it is possible to offset distribution of optimum common electric potentials over a line perpendicular to the source signal lines. In other words, by setting the center electric potential of the source driver output with the use of the present embodiment, it is possible to cause distribution of optimum common electric potential to be uniform. Thus, it is possible that in-plane flicker be prevented.

The following description discusses, as to each of the three offset patterns, concrete means for offsetting distribution of optimum common electric potentials over a line perpendicular to the source signal lines.

(Offset of Distribution of Optimum Common Electric Potential Over a Line Perpendicular to Source Signal Lines which Distribution Arises Due to Feed-Through Electric Potential by Signal Delay of Gate Signal)

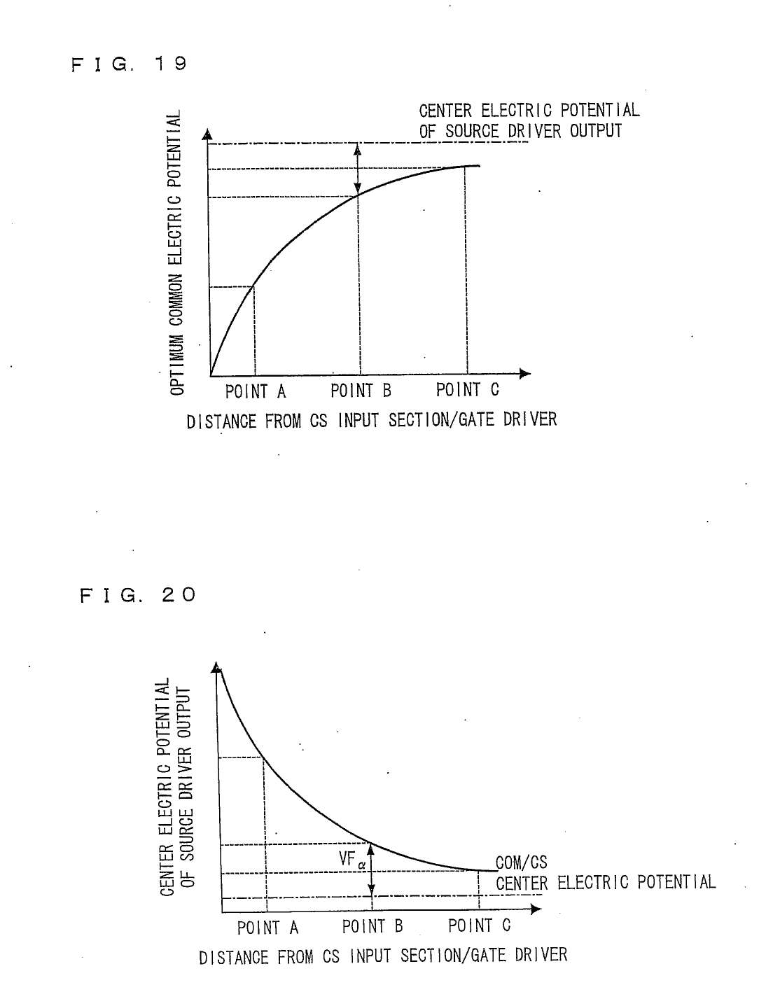

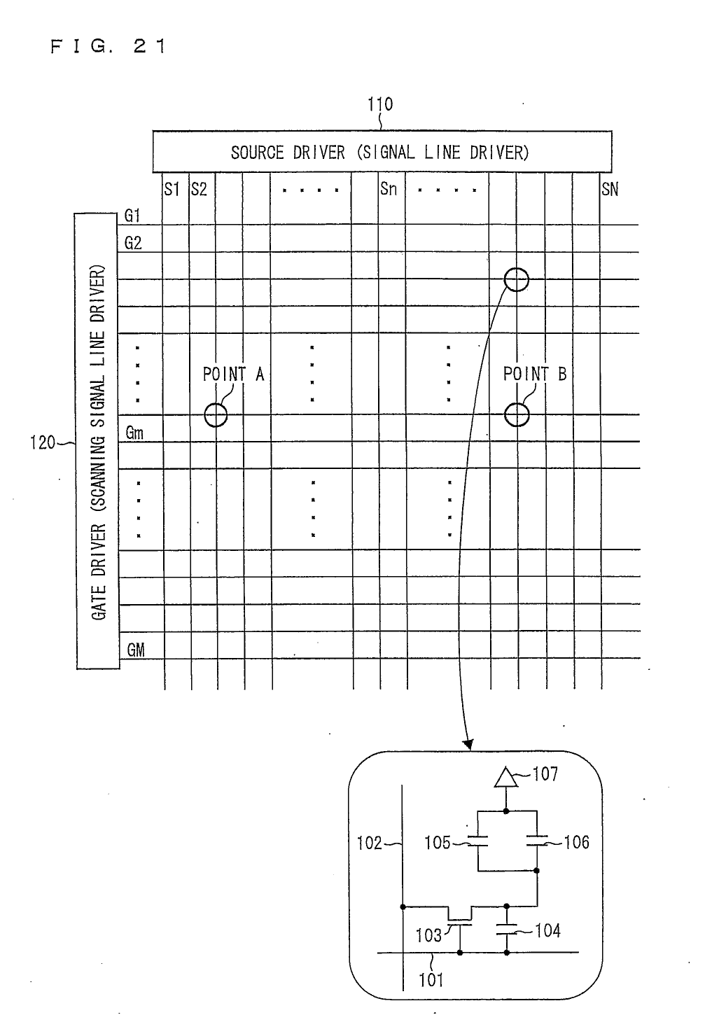

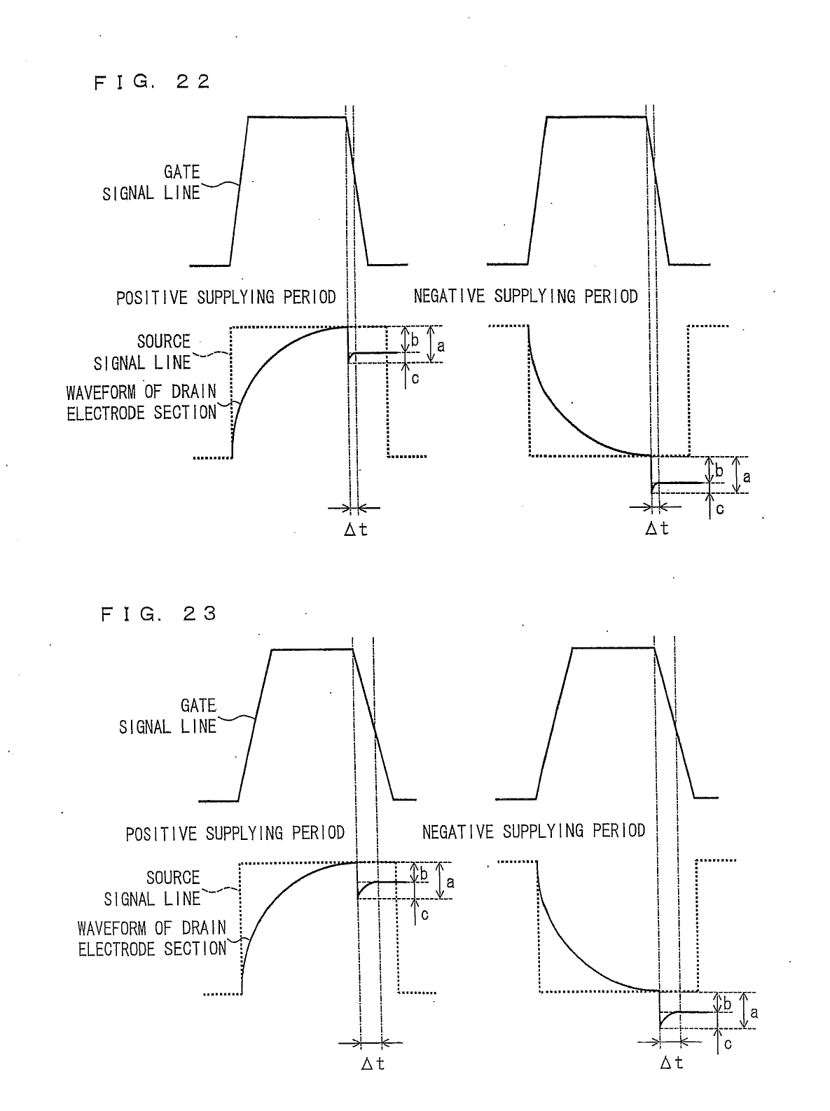

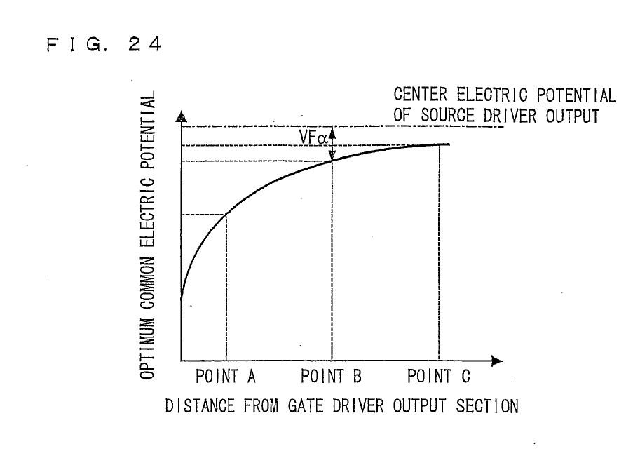

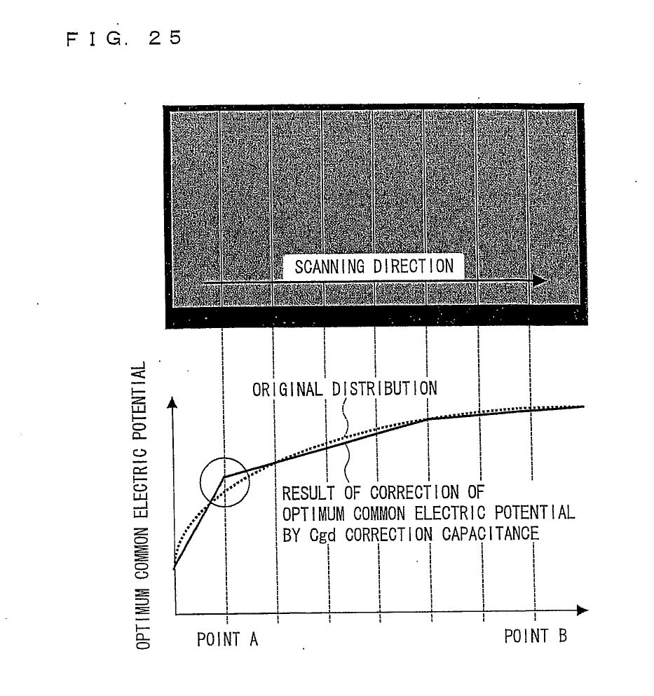

As described earlier, a size of delay of a gate signal waveform varies in accordance with how far a gate to which a corresponding gate signal is outputted is distanced from the gate driver output section. Also, a field-through electric potential residing in an area farther from the gate driver output section is smaller. Thus, an optimum common electric potential at a common electrode provided farther from the gate driver output section is greater as shown in FIG. 20.

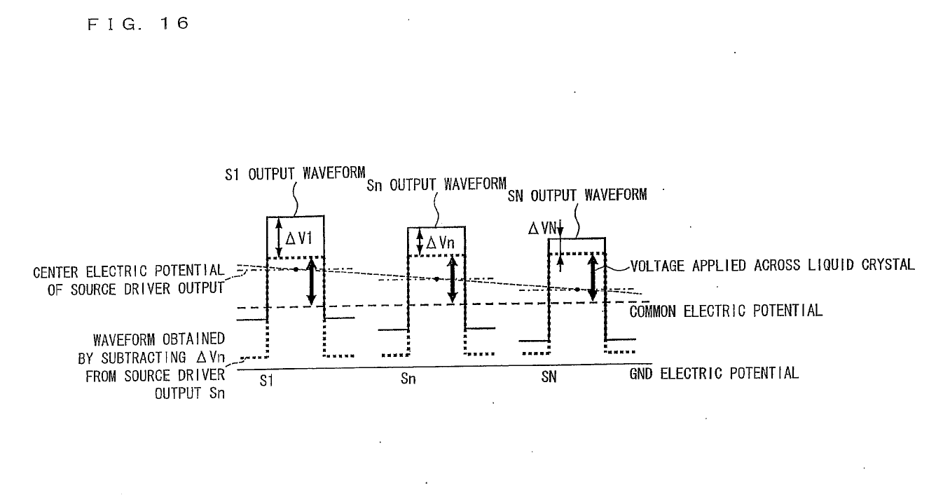

Taking these into account, the inventors of the subject application paid attention to the configuration that the source signal lines are arranged at even intervals from the gate driver output section, in effort of offsetting the distribution of optimum common electric potentials over the line perpendicular to the source signal lines. As a result of this, it is arranged so that a center electric potential of a source driver output is set higher by a degree of a feed-through electric potential, as shown in FIG. 16. That is, the center electric potential of the source driver output is set higher in inversely proportional to a distance from the gate driver output section 12 to a corresponding source signal line.

In still other words, in an area closer to the gate driver output section, an effective field-through voltage is greater, and thus, a center electric potential of the source driver output is set higher. On the other hand, in an area farther from the gate driver output section, an effective field-through voltage is smaller, and thus, a center electric potential of the source driver output is set lower.

This is described in detail a follows. As shown in FIG. 16, output signal lines (source signal lines) S1, S2, Sn, . . . , and SN of the source driver are arranged in this order from the gate driver output. In a case where a field-through electric potential to the output signal line SN is ΔV, it tends that ΔV1>ΔV2> . . . >ΔVn> . . . >ΔVN. In the present embodiment, each of the center electric potentials of the source driver outputs is set higher by a degree of a corresponding difference of ΔV (this is shown by a slope line in FIG. 16). By this, it is possible to offset distribution of optimum electric potentials. This in turn makes it possible to offset the distribution of optimum electric potentials over the line perpendicular to the source signal lines, thereby making it possible to prevent in-plane flicker.

[Offset of Distribution of Optimum Common Electric Potentials over a Line Perpendicular to Source Signal Lines which Distribution Arises Due to an Feed-Through Electric Potential by a Cs Electric Potential]

In a case where storage capacitor signal lines are inputted from one end, in an area closer to a storage capacitor signal input section, a feed-through electric potential by a Cs electric potential is small. As such, a drain electric potential of a TFT in the area recovers quickly after being affected by feed-through. On the other hand, in an area farther from the storage capacitor signal input section, a feed-through electric potential by the Cs electric potential is greater. As such, a drain electric potential of a TFT in the area recovers more slowly after being affected by feed-through. Therefore, optimum common electric potentials in plane are greater in the area farther from the storage capacitor signal input section. As such, optimum common electric potentials in the area farther from the storage capacitor signal input section are greater as shown in FIG. 6.

Therefore, in order that the distribution of the optimum common electric potentials over the line perpendicular to the source signal lines is offset, it is set so that, as shown in FIG. 17, a center electric potential of a source driver output is set lower as a distance from the input section of the storage capacitor signal is greater. By this, it is possible to offset the distribution of the optimum common electric potentials over the line perpendicular to the source signal lines. It is therefore possible to prevent flicker.

On the other hand, in a case where storage capacitor signals are inputted from two ends in a line parallel to the gate signal lines, (i) in an area closer to the gate driver output section and in an area farthest from the gate driver output section, feed-through electric potentials by Cs electric potentials are so small that drain electric potentials of TFTs in the respective areas recover quickly after being affected by feed-through, and (ii) in an area around a halfway point between the gate driver output section and the area farthest from the gate driver output section, a feed-through electric potential by a Cs electric potential is so large that a drain electric potential of a TFT in the area recovers more slowly after being affected by feed-through. Accordingly, distribution of the optimum common electric potentials in plane is of a convex upward function, as shown in FIG. 10.

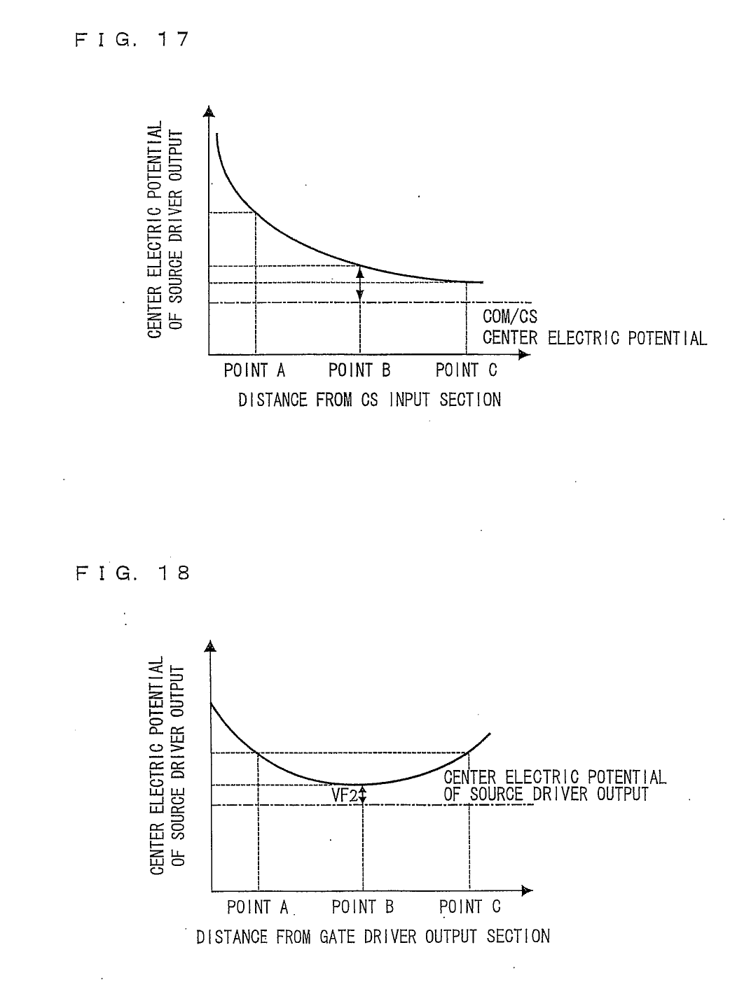

Thus, in order that the distribution of the optimum common electric potentials over the line perpendicular to the source signal lines is offset, it is set so that, as shown in FIG. 18, output center electric potentials of the source drivers are of a downward convex function. This makes it possible to offset the distribution of the optimum common electric potentials over the line perpendicular to the source signal lines. It is therefore possible to prevent in-plane flicker.

[Offset of Distribution of Optimum Common Electric Potentials Over a Line Perpendicular to Source Signal Lines which Distribution Arises Due to Feed-Through Electric Potentials by Signal Delay of a Gate Signal and Feed-Through Electric Potentials by CS Electric Potentials]

The following description discusses offset of distribution of optimum common electric potentials over a line perpendicular to source signal lines which distribution arises due to feed-through electric potentials by signal delay of a gate signal and feed-through electric potentials by CS electric potentials.

At first, the following description discusses the offset of the distribution as to a case in which storage capacitor signals are inputted from one end. The distribution of the optimum common electric potentials over the line perpendicular to the source signal lines is distribution of optimum common electric potentials which, at each point of the line, is exposed to influence of a feed-through electric potential by signal delay of a gate signal and influence of a feed-through electric potential by a CS electric potential. That is, the distribution of the optimum common electric potentials over the line perpendicular to the source signal lines is distribution of optimum common electric potentials which, at each point of the line, is shifted by a degree of a total electric potential of a feed-through voltage by signal delay of a gate signal and a feed-through voltage by feed-through by a CS electric potential. Thus, the distribution of the optimum common electric potentials is as shown in FIG. 19. FIG. 19 shows the distribution of the optimum common electric potentials as to a case where CS signals and gate signals are inputted from a same end.

As described earlier, a center electric potential of a source driver output for offsetting the distribution of optimum common electric potentials over the line perpendicular to the source signal lines which distribution arises due to signal delay of a gate signal is smaller as the center electric potential of the source driver output is outputted to a source signal line provided farther from the gate driver output section. Similarly to this, a center electric potential of a source driver output for offsetting the distribution of optimum common electric potentials over the line perpendicular to the source signal lines which distribution arises due to feed-though by a CS electric potential is smaller as the center electric potential of the source driver output is outputted to a source signal line provided farther from the gate driver output section.

As such, as shown in FIG. 20, a center electric potential of a source driver output for offsetting the distribution of optimum common electric potentials over the line perpendicular to the source signal lines which distribution arises due to feed-through electric potentials by signal delay of a gate signal and feed-through electric potentials by CS electric potentials is smaller as the center electric potential of the source driver output is outputted to a source signal line provided farther from the gate driver output section.

Next, the following description discusses the offset of the distribution as to a case in which storage capacitor signals are inputted from two ends.

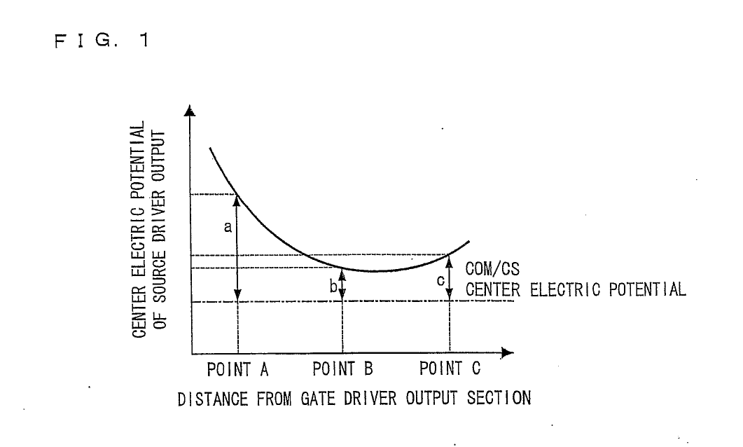

In this case, similarly, the distribution of optimum common electric potentials over the line perpendicular to the source signal lines is distribution of optimum common electric potentials which is lowered, at each point of the line, by a total degree of a feed-through electric potential by signal delay of a gate signal and a feed-through electric potential by a CS electric potential. Thus, the distribution of optimum common electric potentials is as shown in FIG. 11. For example, in a center part (point B) of a liquid crystal panel, a feed-through electric potential b is equivalent to a total value of a feed-through electric potential α shown in FIG. 20 and a feed-through electric potential β shown in FIG. 10. Thus, the center electric potentials of the source driver outputs for offsetting the distribution of the optimum common electric potentials over the line perpendicular to the source signal lines are set so that, a shown in FIG. 1, a center electric potential of a source driver is greater as a distance from a certain point (halfway point between points B and C) of a liquid crystal panel (display surface), which is slightly off from a center of the liquid crystal panel, is greater. By this, it is possible to offset the distribution of the optimum common electric potentials over the line perpendicular to the source signal lines.

### Example

The following description discusses a voltage of a source driver output as to a case of a feature shown in FIG. 1, by using specific numeric examples. Designed voltages were a=100 mV, b=28 mV, and c=40 mV.

A gradation reference voltage generating configuration of a driver IC was as shown in FIG. 13. Reference voltages were V0P=4.596 V, V1023P=0.500 V, V0N=0.500 V, and V1023N=4.596 V. In this case, an amount by which a reference voltage changes per gradation was:

|Vn+1P−VnP|=|Vn+1N−VnN|=4 [mV].

In this case, offset addition values for source driver outputs which drive source signal lines at the respective points A, B, and C were a=25 [100 mV/4 mV], b=7, and c=10.

Let it be assumed that “50 gradation” was outputted. Hereinafter, such outputs were referred to as Vx50P (positive polarity output gradation for display of 50 gradation at a point x) and Vx50N (negative polarity output gradation for display of 50 gradation at the point x).

In this case, a source center electric potential (reference center voltage) was:

(V50P+V50N)/2=(4.396+0.7)/2=2.548 [V].

At the point A, an output value for which offset calculation had been made was:

Va50P=V25P, and Va50N=V75N.

A center electric potential at the point A is:

(V25V+V75N)/2=(4.496+0.8)/2=2.648 [V].

At the point B, an output value for which offset calculation had been made was:

Vb50P=V43P, and Vb50N=V75N.

A center electric potential at the point A is:

(V43P+V57N)/2=(4.424+0.728)/2=2.576 [V].

At the point C, an output value for which offset calculation had been made was:

Vc50P=V40P, and Vc50N=V60N.

A center electric potential at the point A is:

(V40P+V60N)/2=(4.436+0.74)/2=2.588 [V].

Therefore, it is possible that while source output amplitude as designed were maintained, only the center electric potentials of the source outputs be shifted by offset as designed.

The present invention can be described as follows. That is, output center electric potentials of source driver outputs are varied in such a manner that a difference between (i) an output center electric potential of a source driver output (A) for driving a source bus line provided closer to a gate driver output and (ii) an output center potential of a source driver output (B) for driving a source bus line provided farther from the gate driver output has a constant slope. By this, it is possible that a difference in feed-through voltages be offset, and this in turn makes it possible that the problem of in-plane flicker be improved.

A difference between the present invention and a conventional technique can be described as follows. That is, in some liquid crystal displays of a low-temperature polysilicon type, such operation as three-division driving or six-division driving is employed in order that the number of signal lines can reduced (in a case of the three-division driving, each output terminal of the driver is connected to a signal line which is switched among three signal lines in a time-sharing manner, whereas in a case of the six-division driving, each output terminal of the driver is connected to a signal line which is switched among six signal lines in a time-sharing manner). In such liquid crystal panels, since the dividing number is so small that a moderate slope can be realized. In other liquid crystal displays in which no time-sharing operation is performed, one signal line is allocated to each output terminal of the driver.

Since an output voltage deviation of the source driver is normally kept small between 10 to 20 mV or smaller, a variation of the output voltage deviation of the source driver arising from a manufacture process is small. Further, unlike the Cgd gradation, it is unnecessary that a design within a panel be modified, and therefore, there is no factor that causes deterioration of display quality. Moreover, in a majority of source driver ICs for use in small-sized to middle-sized liquid crystal devices, settings can be easily modified by external control such as modification of settings of serial communication or the like. Thus, it is even possible that the settings of each IC be adjusted independently in accordance with an individual difference of a panel and/or IC.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is suitably application for, for example, a small-sized to middle-sized liquid crystal display for use in a mobile device. However, a liquid crystal display for which the present invention is applicable is not limited to such size or such use.

### REFERENCE SIGNS LIST

16 offset adder circuit

1.-8. (canceled)

9. A video signal line driving circuit for driving video signal lines formed in a liquid crystal display device, wherein:
the video signal line driving circuit varies, by using a predetermined offset value, a center electric potential of an output signal in accordance with to which video signal line the output signal is to be outputted; and
the predetermined offset value is set so that the center electric potential of the output signal is greater as the video signal line is farther from an approximate center of a display surface of the liquid crystal display device toward at least one end of the display surface.

10. A video signal line driving circuit for driving video signal lines formed in a liquid crystal display device, wherein:
the video signal line driving circuit varies, by using a predetermined offset value, a center electric potential of an output signal in accordance with to which video signal line the output signal is to be outputted; and
the predetermined offset values is set so that the center electric potential of the output signal is greater as the video signal line is farther from a certain position of a display surface of the liquid crystal display device toward at least one end of the display surface, which certain position of the display surface is closer to one end of the display surface than an approximate center of the display surface to the one end of the display surface.

11. The video signal line driving circuit as set forth in claim 9, wherein:
the predetermined offset value is determined in accordance with distribution of an optimum common-electrode electric potential over a line perpendicular to the video signal lines, which optimum common-electrode electric potential is calculated by a flicker minimum value determining method.

12. The video signal line driving circuit as set forth in any one of claims 9, comprising an offset adder circuit that stores the predetermined offset value.

13. A liquid crystal display device, comprising:
video signal lines and scanning signal lines, which intersect with one another;
a video signal line driving circuit for driving the video signal lines, which video signal line driving circuit varies, by using a predetermined offset value, a center electric potential of an output signal in accordance with to which video signal line the output signal is to be outputted;
a scanning signal line driving circuit for driving the scanning signal lines; and
a storage capacitor signal source for supplying storage capacitor signals, from two ends of the liquid crystal display device, in lines parallel with the scanning signal lines,
the predetermined offset value being set so that the center electric potential of the output signal is greater as the video signal line is farther from an approximate center of a display surface of the liquid crystal display device toward at least one end of the display surface.

14. A liquid crystal display device, comprising:
video signal lines and scanning signal lines, which intersect with one another;
a video signal line driving circuit for driving the video signal lines, which video signal line driving circuit varies, by using a predetermined offset value, a center electric potential of an output signal in accordance with to which video signal line the output signal is to be outputted;
a scanning signal line driving circuit for driving the scanning signal lines; and
a storage capacitor signal source for inputting storage capacitor signals, from two ends of the liquid crystal display device, in lines parallel with the scanning signal lines,
the predetermined offset value being set so that the center electric potential of the output signal is greater as the video signal line is farther from a certain position of a display surface of the liquid crystal display device toward at least one end of the display surface, which certain position of the display surface is closer to the scanning signal line driving circuit than an approximate center of the display surface to the scanning signal line driving circuit.

15. The liquid crystal display device as set forth in claim 13, wherein:
the predetermined offset value is determined in accordance with distribution of an optimum common-electrode electric potential over a line perpendicular to the video signal lines, which optimum common-electrode electric potential is calculated by a flicker minimum value determining method.

16. The liquid crystal display device as set forth in any one of claims 13, wherein:
the video signal line driving circuit includes an offset adder circuit that stores the predetermined offset value.

17. The video signal line driving circuit as set forth in claim 10, wherein:
the predetermined offset values are determined in accordance with distribution of optimum common-electrode electric potentials over a line perpendicular to the video signal lines, which optimum common-electrode electric potentials are calculated by a flicker minimum value determining method.

18. The video signal line driving circuit as set forth in claim 10, comprising an offset adder circuit that stores the predetermined offset values.

19. The liquid crystal display device as set forth in claim 14, wherein:
the predetermined offset values are determined in accordance with distribution of optimum common-electrode electric potentials over a line perpendicular to the video signal lines, which optimum common-electrode electric potentials are calculated by a flicker minimum value determining method.

20. The liquid crystal display device as set forth in claim 14, wherein:
the video signal line driving circuit includes an offset adder circuit that stores the predetermined offset values.

21. The video signal line driving circuit as set forth in claim 9, wherein:
the predetermined offset values are such that center electric potentials of output signals are greater for farther video signal lines away from the approximate center of the display surface toward respective different ends of the display surface.

22. The video signal line driving circuit as set forth in claim 10, wherein:
the predetermined offset values are such that center electric potentials of output signals are greater for farther video signal lines away from the certain position of the display surface toward respective different ends of the display surface.

23. The video signal line driving circuit as set forth in claim 13, wherein:
the predetermined offset values are such that center electric potentials of output signals are greater for farther video signal lines away from the approximate center of the display surface toward respective different ends of the display surface.

24. The video signal line driving circuit as set forth in claim 14, wherein:
the predetermined offset values are such that center electric potentials of output signals are greater for farther video signal lines away from the certain position of the display surface toward respective different ends of the display surface.
